(19) United States
(12) Patent Application Publication
(10) Pub. No.: US 2025/0293464 A1
(43) Pub. Date: Sep. 18, 2025

(54) Protection grounding assembly, integral module comprising same, integral module assembly and plug-in connector

(71) Applicant: HARTING Electric Stiftung & Co. KG, Espelkamp (DE)

(72) Inventors: Dongyuan Zeng, Zhuhai (CN); Miaoqing Luo, Zhuhai (CN)

(73) Assignee: HARTING Electric Stiftung & Co. KG, Espelkamp (DE)

(21) Appl. No.: 19/071,686

(22) Filed: Mar. 5, 2025

(30) Foreign Application Priority Data
Mar. 14, 2024 (CN) 202410291160.X

(51) Int. Cl. H01R 13/652

(52) U.S. Cl. CPC H01R 13/652

(57) ABSTRACT

A protection grounding assembly (4, 4′) includes a protection grounding plate (5, 5′) and a protection grounding contact (6, 6′). The protection grounding plate (5, 5′) has a flat plate part (51) and two support legs (52) that extend from the flat plate part. The flat plate part (51) has a round opening (53) for the protection grounding contact (6, 6′) to pass through, and the round opening (53) has an annular protrusion (531) for retaining an outer peripheral knurl (61) of the protection grounding contact (6, 6′). An integral module includes the protection grounding assembly (4, 4′), a unitary insulator (2) and a retention plate (3) that is able to lock to the insulator (2).

### CROSS-REFERENCE TO RELATED APPLICATION

This application claims the benefit of Chinese Patent Application CN 202410291160.X, filed on Mar. 14, 2024, the content of which is incorporated in its entirety.

### TECHNICAL FIELD

The present disclosure relates to a protection grounding assembly for a connector and an integral module that comprises the protection grounding assembly. In addition, the present disclosure relates to an integral module assembly, which is composed of the integral module and a matching integral module or a modular insert. In addition, the present disclosure relates to a plug-in connector which comprises the integral module assembly.

### BACKGROUND

Common industrial heavy-duty plug-in connectors currently on the market, such as the 70A Han-Modular series, are systems composed of modular inserts 8, 8′ and die-cast frames 9, as shown in FIG. 13. The modular insert 8 is composed of multiple modules 81, each module being provided with at least two contact cavities for accommodating contacts for transmitting power, signals and data, and each being provided with a locking lug located at two sides to lock to a locking window of a frame. The frame is generally formed from metal, for example by copper die-casting. When this modular system is composed of multiple modules and assembled, it is necessary to insert the modules connected one-by-one into the open frame, and then close the frame, resulting in complex manufacture and high costs.

### SUMMARY

An object of the present disclosure lies in providing an integral module that is easy to manufacture, which integrates a frame and a module into one product, thus simplifying a manufacturing process and reducing manufacturing costs by not using a die-cast frame. This integral module may further be compatible with an existing modular insert.

According to one aspect of the present disclosure, a protection grounding assembly is provided, comprising a protection grounding plate and a protection grounding contact, wherein the protection grounding plate has a flat plate part and two support legs that extend from the flat plate part, wherein the flat plate part has a round opening for the protection grounding contact to pass through, and the round opening has an annular protrusion for retaining an outer peripheral knurl of the protection grounding contact. Thus, the annular protrusion cooperates with the outer peripheral knurl, greatly increasing a retention force between the protection grounding plate and the protection grounding contact.

In a preferred embodiment, the flat plate part comprises a rectangular opening. In a preferred embodiment, the flat plate part further has at least one and preferably two screw holes for a screw to pass through. The screw is used for screwing into a cover or casing. Preferably, two support legs respectively extend at an obtuse angle from the flat plate part.

According to one aspect, an integral module is provided, the integral module comprising the protection grounding assembly, a unitary insulator and a retention plate that is able to lock to the insulator, wherein the insulator has two mutually opposing long sides oriented in a longitudinal direction, two mutually opposing narrow sides that are perpendicular to the long sides and are oriented in a transverse direction, and multiple contact cavities that extend in a plug-in direction, wherein the protection grounding assembly is arranged on the narrow side, wherein the protection grounding plate is fixed by the insulator in the longitudinal direction and the transverse direction, and is fixed by the retention plate in the plug-in direction.

In one embodiment, the narrow side of the insulator has a fixing part for fixing the protection grounding assembly, wherein the fixing part has a U-shape fixing plate and a mounting part, wherein the U-shape fixing plate comprises a straight plate part and two parallel side plate parts, wherein accommodating parts formed by the side plate parts and the mounting part are respectively used for accommodating the support legs of the protection grounding plate, so as to fix the protection grounding plate in the longitudinal direction and the transverse direction. Specifically, a left side plate part and the mounting part form one accommodating part, and a right side plate part and the mounting part form another accommodating part, and the two accommodating parts respectively correspond to one support leg of the protection grounding plate.

In one embodiment, the straight plate part has a guide pin and a round hole for the protection grounding contact to pass through.

In a preferred embodiment, the guide pin can be constructed as a male guide pin or a female guide pin, wherein the female guide pin is arranged at a round hole of the straight plate part, extends in the plug-in direction and has an auxiliary member integral therewith, and the auxiliary member has a rectangular protrusion that extends counter to the plug-in direction, wherein the male guide pin is arranged at one side of the round hole of the straight plate part, extends in the plug-in direction and has a rectangular protrusion that extends counter to the plug-in direction, wherein the rectangular protrusions are respectively used for insertion into rectangular openings of the protection grounding plates, thereby fixing the protection grounding plate in the plug-in direction.

In one embodiment, the retention plate has two mutually opposing long sides oriented in the longitudinal direction, and two mutually opposing narrow sides that are perpendicular to the long sides and are oriented in the transverse direction, wherein the narrow sides both have a U-shape retention part comprising two leg parts, wherein the long side is a side plate, wherein slots between the leg parts and the corresponding side plates are respectively used for accommodating the side plate parts of the insulator, and the leg parts both abut one of the support legs of the protection grounding plate in the plug-in direction, thereby fixing the protection grounding plate in the plug-in direction. In a preferred embodiment, the leg part is provided with a step part at a top part thereof, and the step part abuts the support leg of the protection grounding plate.

In one embodiment, the side plates of the retention plate both have at least one locking window to lock at least one corresponding locking lug of the insulator, and the retention plate has multiple retention arms extending in the plug-in direction to retain contacts accommodated in the contact cavities of the insulator.

According to another aspect, an integral module assembly is provided, composed of the integral module and a matching integral module or a modular insert having a frame.

According to another aspect, a plug-in connector is provided, having the integral module assembly.

### BRIEF DESCRIPTION OF THE DRAWINGS

Exemplary embodiments of the present invention are shown in the drawings and explained in detail below.

FIG. 1 shows a 3D view of a (male) integral module according to an embodiment of the present invention;

FIG. 2 shows a side view of the (male) integral module shown in FIG. 1;

FIG. 3 shows an exploded view of the (male) integral module shown in FIG. 1;

FIGS. 4 and 5 show a view of an insulator from different angles;

FIG. 6 shows a 3D view of a (female) protection grounding assembly;

FIG. 7 shows a 3D view of a protection grounding plate of a (female) protection grounding assembly;

FIG. 8 shows a 3D view of a (female) protection grounding contact of a (female) protection grounding assembly;

FIG. 9 shows a 3D view of a (male) protection grounding assembly;

FIG. 10 shows a 3D view of a protection grounding plate of a (male) protection grounding assembly;

FIG. 11 shows a 3D view of a (male) protection grounding contact of a (male) protection grounding assembly;

FIG. 12 shows a 3D view of a (female) integral module according to an embodiment of the present invention;

FIG. 13 shows an exploded view of an integral module and a modular insert.

The drawings include partially simplified schematic drawings. In certain situations, the same reference labels are used for the same but possibly different elements. Different views of the same element may be scaled differently.

### DETAILED DESCRIPTION

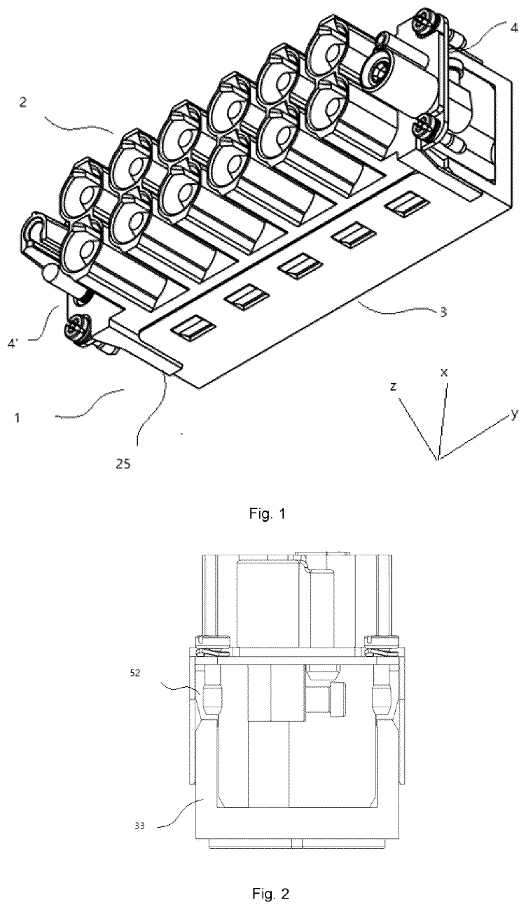

FIGS. 1-3 show a 3D view, a side view and an exploded view of an integral module 1 according to an embodiment of the present application. The integral module 1 is constructed as a male integral module. The integral module 1 comprises a unitary insulator 2, a retention plate 3 and a protection grounding (PE) assembly 4, 4′, that is, a male protection grounding assembly 4′ and a female protection grounding assembly 4.

The insulator 2 is formed by injection moulding a plastic material, and has an overall rectangular shape, having two mutually opposing long sides oriented in a longitudinal y-direction, and two mutually opposing narrow sides that are perpendicular to the long sides and are oriented in a transverse x-direction. At least one and preferably multiple locking lugs 29 are formed on the long side. A plurality (two rows) of contact cavities 21 are integrally formed in the insulator, and the contact cavities extend through the insulator in a plug-in z-direction for accommodating contacts 7, in this case male contacts. Fixing parts 22, 22′ for fixing protection grounding assemblies 4, 4′ are formed on the two narrow sides of the insulator, wherein the male fixing part 22′ is used for fixing the male protection grounding assembly 4′, and the female fixing part 22 is used for fixing the female protection grounding assembly 4.

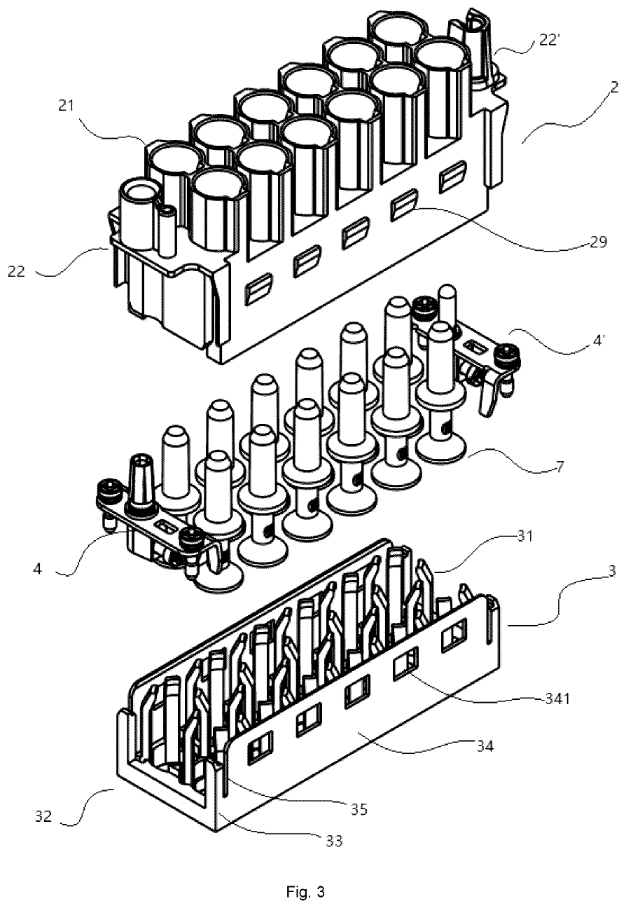

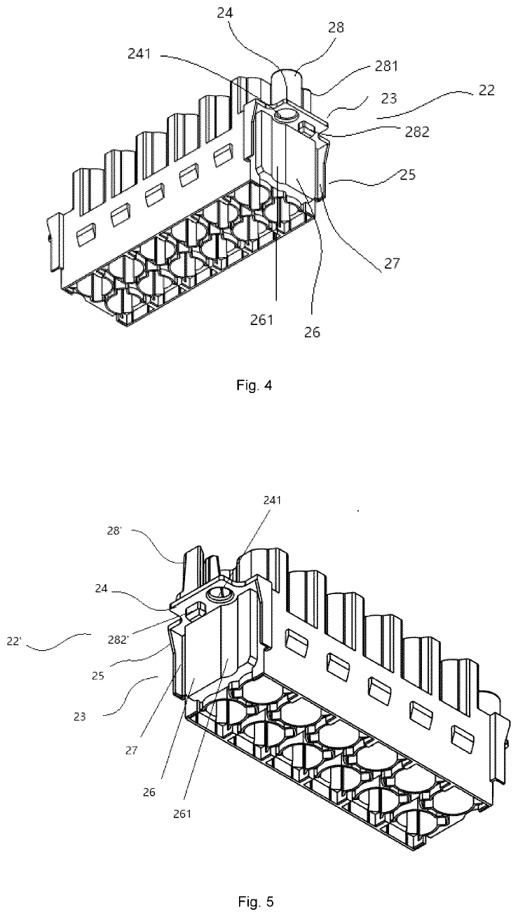

The female fixing part 22 and the male fixing part 22′ will now specifically be described in view of FIGS. 4 and 5. The female fixing part 22 and the male fixing part 22′ both have a U-shape fixing plate 23 and a mounting part 26. The U-shape fixing plate 23 comprises a straight plate part 24 and two parallel side plate parts 25. The straight plate part 24 extends in the longitudinal y-direction and the transverse x-direction, and has a round hole 241 and a guide pin 28, 28′, that is, a male guide pin 28′ and a female guide pin 28. As shown in FIGS. 3 and 4, the female fixing part 22 has a female guide pin 28 and an auxiliary member 281 integral with the female guide pin; the female guide pin 28 is a hollow cylinder, and is arranged in the round hole 241 (aligned with the round hole) and extends in the plug-in z-direction, that is, extends above the straight plate part 24, and the auxiliary member 281 has a rectangular protrusion 282 extending counter to the plug-in z-direction, that is, extending below the straight plate part 24. As shown in FIGS. 3 and 5, the male fixing part 22′ has a male guide pin 28′; this male guide pin is arranged at one side of the round hole 241 and extends in the plug-in z-direction, that is, extends above the straight plate part 24, and the male guide pin has a rectangular protrusion 282′ extending counter to the plug-in z-direction, that is, extending below the straight plate part 24. The side plate part 25 extends counter to the plug-in z-direction perpendicular to the straight plate part 24. The mounting part 26 protrudes from a side face of the narrow side of the insulator 2 and has a guide slot 261. Two sides of the mounting part 26 respectively form accommodating parts 27 together with the corresponding side plate parts 25.

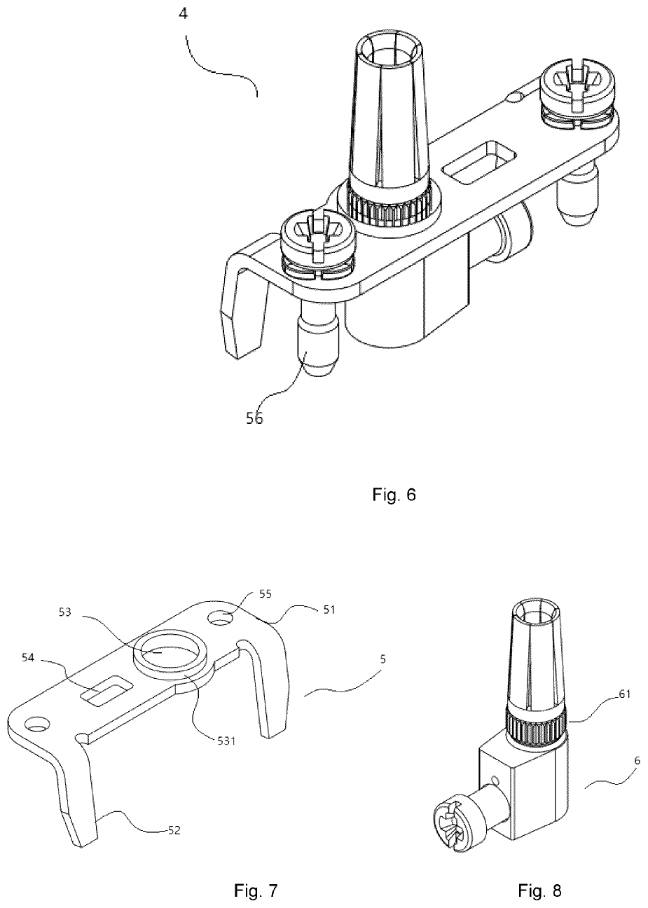

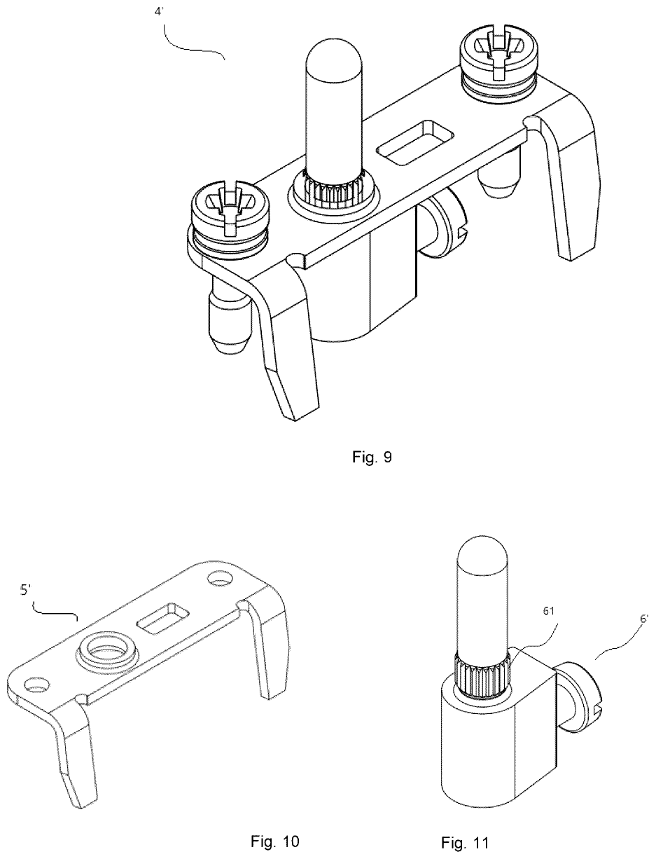

FIG. 6 shows a female protection grounding assembly 4. The female protection grounding assembly 4 is formed by a protection grounding plate 5 and a female protection grounding contact 6. FIG. 7 shows a protection grounding plate 5, which has a flat plate part 51 and two support legs 52 that extend at an obtuse angle from the flat plate part. The flat plate part 51 has a round opening 53, a rectangular opening 54 and a screw hole 55, and the round opening has an annular protrusion 531. FIG. 8 shows a female protection grounding contact 6, and an outer peripheral knurl 61 is formed at an outer peripheral face of the contact. When assembled, the female protection grounding contact 6 passes through the round opening 53, and the annular protrusion 531 is joined to the outer peripheral knurl 61 of the female protection grounding contact 6 that passes through the round opening 53, so as to increase a retention force, thereby firmly retaining the protection grounding contact on the protection grounding plate. FIG. 9 shows a male protection grounding assembly 4′. The protection grounding assembly 4′ is composed of a protection grounding plate 5′ and a male protection grounding contact 6′. As shown in FIG. 10, the protection grounding plate 5′ of the male protection grounding assembly 4′ is roughly the same as the protection grounding plate 5 of the female protection grounding assembly, apart from the positions of the round opening and the rectangular opening, and therefore reference numerals for the components thereon are omitted. When assembled, the male protection grounding contact 6′ shown in FIG. 11 also passes through the round opening 53, and the annular protrusion 531 is joined to the outer peripheral knurl 61 of the male protection grounding contact 6′ that passes through the round opening 53. A screw 56 is mounted in a screw hole 55 for screwing into a cover or casing (not shown) of a plug-in connector.

Now returning to FIG. 3, a retention plate 3 is shown. The retention plate is overall a U-shape, and has two mutually opposing long sides oriented in a longitudinal y-direction, two mutually opposing narrow sides that are perpendicular to the long sides and are oriented in a transverse x-direction, and a bottom face. The long side of the retention plate is a side plate 34, which is elastic, and at least one and preferably multiple locking windows 341 are provided on the side plate. The two narrow sides of the retention plate both have a U-shape retention part 32, which comprises two leg parts 33. Each long side is provided with two slots 35 between the side plate 34 and the leg parts 33. The bottom face is provided with multiple openings (not shown) corresponding to contact cavities 21, and each opening is provided with at least two retention arms 31 extending in the plug-in z-direction (above the bottom face).

The assembly process of the integral module 1 is now described in detail.

Firstly, the assembled protection grounding assembly 4, 4′ is mounted on the insulator 2. Specifically, the female protection grounding contact 6 of the female protection grounding assembly 4 passes along the guide slot 261 of the mounting part 26 and through the round hole 241 of the straight plate part 24 of the female fixing part 22 and inserts into the hollow female guide pin 28, while the rectangular protrusion 282 of the auxiliary member 281 inserts into the rectangular opening 54 of the protection grounding plate 5, thus fixing the straight plate part 24 of the female fixing part 22 and the flat plate part 51 of the protection grounding plate 5 in the plug-in z-direction (see FIG. 1). Similarly, the male protection grounding contact 6′ of the male protection grounding assembly 4′ passes along the guide slot 261 and through the round hole 241 of the straight plate part 24 of the male fixing part 22′, while the rectangular protrusion 282′ of the male guide pin 28′ inserts into the rectangular opening 54 of the protection grounding plate 5′, thus fixing the straight plate part 24 of the male fixing part 22′ and the flat plate part 51 of the protection grounding plate 5′ in the plug-in z-direction. The two support legs 52 of the protection grounding plate 5, 5′ respectively insert into two accommodating parts 27 formed by two sides of the mounting part 26 and side plate parts 25, thus fixing the protection grounding plate in the longitudinal y-direction and the transverse x-direction, specifically fixing the support legs thereof. At the same time, the contact 7 (a male contact in this case) may insert into the corresponding contact cavity 21.

Next the retention plate 3 is mounted on the insulator 2 fitted with the protection grounding assembly 4, 4′. Specifically, the retention plate 3 is pushed into the insulator in the plug-in z-direction (from below). The side plate parts 25 of the U-shape fixing plate 23 of the insulator 2 insert into the corresponding slots 35 of the retention plate 3 (shown clearly in FIG. 1). The leg parts 33 of the U-shape retention part 32 of the retention plate 3 abut the corresponding support legs 2 of the protection grounding plate 5 in the plug-in z-direction (shown clearly in FIG. 2, specifically, a step part of a top part of the leg part 33 being used for abutting the support leg), thereby fixing the protection grounding plate in the plug-in z-direction. Thus, a preloading force is applied between the protection grounding plate 5 and the retention plate 3. At the same time, retention arms 31 of the retention plate 3 extend into the corresponding contact cavities 21, retaining the contacts 7 in the contact cavities 21, preventing the contacts from falling out counter to the plug-in direction. The locking lugs 29 of the insulator 2 are locked in the corresponding locking windows 341 of the retention plate 3, so as to achieve locking between the retention plate 3 and the insulator 2. Finally, the assembly of the integral module is completed.

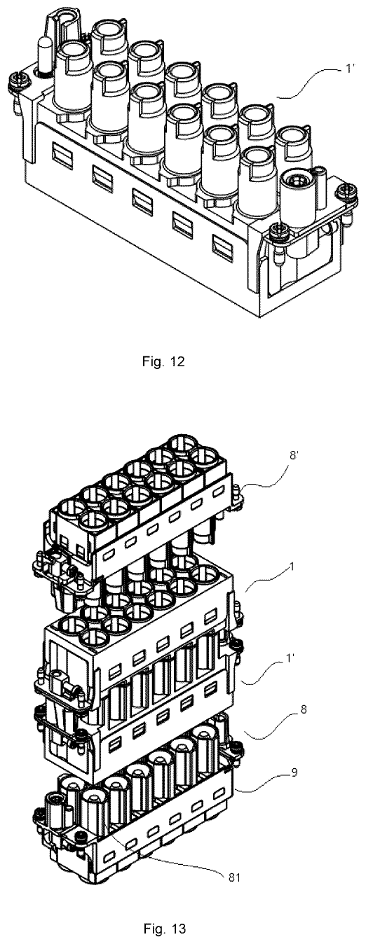

FIG. 12 shows an integral module 1′ according to an embodiment, constructed as a matching integral module 1′ which is able to cooperate with the integral module 1, that is, a female integral module which accommodates a female contact. The structure of the matching integral module 1′ is basically the same as the integral module 1 and is not detailed unnecessarily here.

FIG. 13 shows an exploded view of the integral module 1, 1′ and a conventional modular insert 8, 8′ fitted with a frame 9. The male integral module 1 may plug into the female modular insert 8′, and the male modular insert 8 may plug into the female integral module 1′. Hence, the integral module of the present invention is compatible with an existing modular insert.

Even though different aspects or features of the present invention are respectively shown in combination in the drawings, for a person skilled in the art, unless otherwise stated, obviously the shown and discussed combinations are not uniquely feasible. In particular, mutually corresponding units or feature composites formed by different embodiments may be mutually exchanged.

### REFERENCE NUMERALS

1 integral module
1′ matching integral module
2 insulator
21 contact cavity
22, 22′ fixing part
23 U-shape fixing plate
24 straight plate part
241 round hole
25 side plate part
26 mounting part
27 accommodating part
28, 28′ guide pin
281 auxiliary member
282, 282′ rectangular protrusion
29 locking lug
3 retention plate
31 retention arm
32 U-shape retention part
33 leg part
34 side plate
4, 4′ protection grounding assembly
5, 5′ protection grounding plate
51 flat plate part
52 support leg
53 round opening
531 annular protrusion
54 rectangular opening
55 screw hole
56 screw
6, 6′ protection grounding contact
61 outer peripheral knurl
7 contact
8, 8′ modular insert
81 module
9 frame
341 locking window
35 slot

What is claimed is:

1. A protection grounding assembly (4, 4′), comprising:
a protection grounding plate (5, 5′); and
a protection grounding contact (6, 6′),
wherein the protection grounding plate (5, 5′) has a flat plate part (51) and two support legs (52) that extend from the flat plate part,
wherein the flat plate part (51) has a round opening (53) for the protection grounding contact (6, 6′) to pass through, and
wherein the round opening (53) has an annular protrusion (531) for retaining an outer peripheral knurl (61) of the protection grounding contact (6, 6′).

2. The protection grounding assembly (4, 4′) according to claim 1,
wherein the flat plate part (51) further comprises a rectangular opening (54).

3. An integral module (1), comprising:
the protection grounding assembly (4, 4′) according to claim 1;
a unitary insulator (2); and
a retention plate (3) that is able to lock to the insulator (2),
wherein the insulator (2) has
two mutually opposing long sides oriented in a longitudinal direction (y),
two mutually opposing narrow sides that are perpendicular to the long sides and are oriented in a transverse direction (x), and
multiple contact cavities (21) that extend in a plug-in direction (z),
wherein the protection grounding assembly (4, 4′) is arranged on one of the narrow sides,
wherein the protection grounding plate (5, 5′) is fixed by the insulator (2) in the longitudinal direction (y) and the transverse direction (x), and is fixed by the retention plate (3) in the plug-in direction (z).

4. The integral module (1) according to claim 3,
wherein the narrow side of the insulator (2) has a fixing part (22, 22′) for fixing the protection grounding assembly (4, 4′),
wherein the fixing part (22, 22′) has a U-shape fixing plate (23) and a mounting part (26),
wherein the U-shape fixing plate (23) comprises a straight plate part (24) and two parallel side plate parts (25),
wherein accommodating parts (27) formed by the side plate parts (25) and the mounting part (26) are respectively used for accommodating the support legs (52) of the protection grounding plate (5, 5′), so as to fix the protection grounding plate (5, 5′) in the longitudinal direction (y) and the transverse direction (x).

5. The integral module (1) according to claim 4,
wherein the straight plate part (24) has a guide pin (28, 28′) and a round hole (241) for the protection grounding contact (6, 6′) to pass through.

6. The integral module (1) according to claim 5,
wherein the guide pin (28, 28′) can be constructed as a male guide pin (28′) or a female guide pin (28),
wherein the female guide pin (28) is arranged at a round hole (241) of the straight plate part (24), extends in the plug-in direction (z) and has an auxiliary member (281) integral therewith, and the auxiliary member (281) has a rectangular protrusion (282) that extends counter to the plug-in direction (z),
wherein the male guide pin (28′) is arranged at one side of the round hole (241) of the straight plate part (24), extends in the plug-in direction (z) and has a rectangular protrusion (282′) that extends counter to the plug-in direction (z),
wherein the rectangular protrusions (282, 282′) are respectively used for insertion into rectangular openings (54) of the protection grounding plates (5, 5′), thereby fixing the protection grounding plate in the plug-in direction (z).

7. The integral module (1) according to claim 4,
wherein the retention plate (3) has two mutually opposing long sides oriented in the longitudinal direction (y), and two mutually opposing narrow sides that are perpendicular to the long sides and are oriented in the transverse direction (x),
wherein the narrow sides both have a U-shape retention part (32) comprising two leg parts (33),
wherein the long side of the retention plate is a side plate (34),
wherein slots (35) between the leg parts (33) and the corresponding side plates (34) are respectively used for accommodating the side plate parts (25) of the insulator (2), and
wherein the leg parts (33) both abut one of the support legs (52) of the protection grounding plate (5, 5′) in the plug-in direction (z), thereby fixing the protection grounding plate in the plug-in direction (z).

8. The integral module (1) according to claim 7,
wherein the side plates (34) of the retention plate (3) both have at least one locking window (341) to lock at least one corresponding locking lug (29) of the insulator (2), and
wherein the retention plate (3) has multiple retention arms (31) extending in the plug-in direction (z) to retain contacts (7) accommodated in the contact cavities (21) of the insulator (2).

9. An integral module assembly, comprising
the integral module (1) according to claim 3; and
a matching integral module (1′) or a modular insert (8, 8′) having a frame (9).

10. A plug-in connector, comprising
the integral module assembly according to claim 9.
